(19) United States
(12) Patent Application Publication
(10) Pub. No.: US 2012/0026397 A1
(43) Pub. Date: Feb. 2, 2012

(54) METHOD AND APPARATUS FOR BROWSING CHANNELS IN A DIGITAL TELEVISION DEVICE

(75) Inventor: Srikanth Narayana Reddy GUMMAGATTA, Bangalore (IN)

(73) Assignee: Samsung Electronics Co., Ltd., Suwon-si (KR)

(21) Appl. No.: 13/196,410

(22) Filed: Aug. 2, 2011

(30) Foreign Application Priority Data
Aug. 2, 2010 (IN) 2199/CHE/2010
Jul. 13, 2011 (KR) 10-2011-000069609

(51) Int. Cl. H04N 5/445

(52) U.S. Cl. 348/563; 348/E05.099

(57) ABSTRACT

A method and apparatus for browsing channels in a digital television device, wherein the method includes forming one or more blocks of moving window frames associated with each channel program being watched by a viewer of the digital television device, generating a channel history list based on the one or more blocks of the moving window frames, and displaying the channel history list on a display of the digital television device. The channel history list includes at least one of the channel programs watched by the viewer, information associated with each of the at least one of the channel programs, and a preview of the moving window frames in the one or more blocks associated with each of the at least one of the channel programs.

### PRIORITY

This application claims priority under 35 U.S.C. §119(a) to an Indian Patent Application filed in the Indian Patent Office on Aug. 2, 2010 and assigned Serial No. 2199/CHE/2010, and to a Korean patent application filed in the Korean Intellectual Property Office on Jul. 13, 2011, and assigned Serial No. 10-2011-000069609, the entire disclosure of each of which is hereby incorporated by reference.

### BACKGROUND OF THE INVENTION

1. Field of the Invention

The present invention relates generally to the field of digital television, and more particularly, to a channel browsing method and system.

2. Description of the Related Art

Digital television programming is available from many sources, these include satellite broadcasts, digital cable systems, and terrestrial broadcasts systems. A viewer connected to a digital cable system may, for example, be able to receive up to 1000 channels. This is possible as digital television signals are compressed to eliminate redundancies from line to line and frame to frame and, thus, the required bandwidth for transmitting the signals is reduced.

Channel surfing is a process by which a viewer successively tunes a television receiver to one channel after another in order to find a desired program. Often, after surfing through a number of channels, the viewer may decide to watch a channel program that is being broadcasted on one of the previously surfed channels. However, as the viewer may have surfed through such a large number of channels and may not remember which channel number/channel name is broadcasting the desired channel program. Accordingly, in order to find the channel broadcasting the desired channel program, the viewer may have manually surf backwards from a current channel or restart surfing from the start. This may lead to a poor user experience and may frustrate even the most patient channel surfer.

In order to overcome some of the problems associated with channel surfing, many cable systems provide an Electronic Program Guide (EPG). An EPG allows a viewer to bring up a description of programming currently available on multiple channels, typically in a grid form. By visually scanning the grid, a viewer may determine the programs on any of a number of channels and tune to a channel by selecting an item from the grid. It is difficult, however, to succinctly describe a television program in a grid format, as space is limited.

### SUMMARY OF THE INVENTION

Accordingly, the present invention has been designed to solve some the above-described limitations and problems in the prior art and to provide at least the advantages described below.

In accordance with an aspect of the present invention, a method is provided for browsing channels in a digital television device. The method includes forming one or more blocks of moving window frames associated with each channel program being watched by a viewer of the digital television device; generating a channel history list based on the one or more blocks of the moving window frames; and displaying the channel history list on a display of the digital television device. The channel history list includes at least one of the channel programs watched by the viewer, information associated with each of the at least one of the channel programs, and a preview of the moving window frames in the one or more blocks associated with each of the at least one of the channel programs.

In accordance with another aspect of the present invention, an apparatus is provided for browsing channels in a digital television device. The apparatus includes a display device; a processor that forms one or more blocks of moving window frames associated with each channel program being watched by a viewer of the digital television device, generates a channel history list based on the one or more blocks of the moving window frames, and displays the channel history list on the display of the digital television device; and a memory for storing the one or more blocks and the channel history list. The channel history list includes at least one of the channel programs browsed by the viewer, information associated with each of the at least one of the channel programs, and a preview of the moving window frames in the one or more blocks associated with each of the at least one of the channel programs.

Other features of the embodiments will be apparent from the accompanying drawings and from the detailed description that follows.

### BRIEF DESCRIPTION OF THE DRAWINGS

The above and other aspects, features, and advantages of the present invention will be more apparent from the following detailed description when taken in conjunction with the accompanying drawings, in which:

FIG. 1 is a flowchart illustrating a method of browsing channels in a digital television device, according to an embodiment of the present invention;

FIG. 2 is a flowchart illustrating a method of forming automatic blocks of moving window frames associated with each channel program being watched by a viewer, according to an embodiment of the present invention;

FIG. 3 is a flowchart illustrating a method of forming associated blocks of moving window frames associated with each channel program, according to an embodiment of the present invention;

FIG. 4 is a flowchart illustrating a method of forming dynamic blocks of moving window frames associated with each channel program, according to an embodiment of the present invention;

FIG. 5 is a flowchart illustrating a method of forming a first fixed block of moving window frames associated with each channel program, according to an embodiment of the present invention;

FIG. 6 is a flowchart illustrating a method of forming a last fixed block of moving window frames associated with each channel program, according to an embodiment of the present invention;

FIG. 7 illustrates a screenshot view of an interactive graphical output displayed on a display of a digital television device, according to an embodiment of the present invention; and

FIG. 8 is a block diagram illustrating a digital television device implementing channel browsing, according to an embodiment of the present invention.

### DETAILED DESCRIPTION OF EMBODIMENTS OF THE INVENTION

Various embodiments of the present invention will now be described more fully with reference to the accompanying drawings. The present invention may, however, be embodied in many different forms and should not be construed as limited to the embodiments set forth herein. Rather, these embodiments are provided so that this disclosure will be thorough and complete and will fully convey the scope of the invention to those skilled in the art.

Specifically, a method and system of browsing channels in a digital television device will be described below. The following description is merely exemplary in nature and is not intended to limit the present disclosure, applications, or uses. It should be understood that throughout the drawings, corresponding reference numerals indicate like or corresponding parts and features.

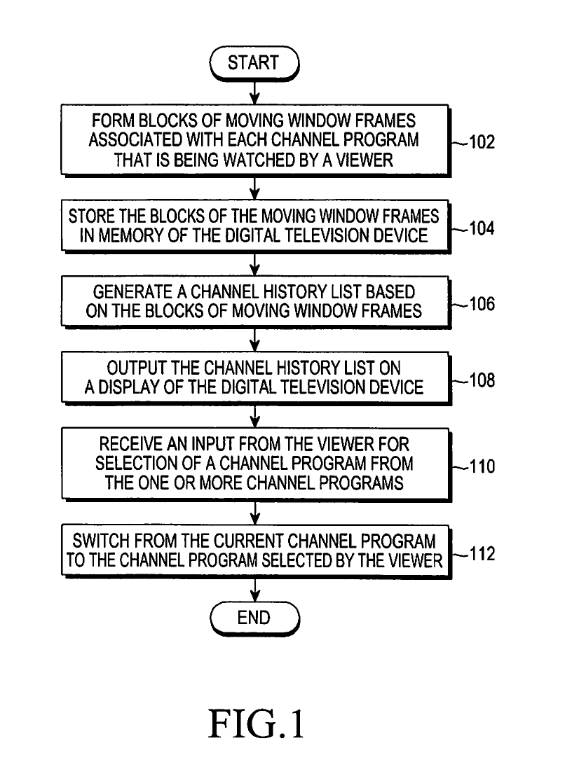

FIG. 1 is a flowchart illustrating a method of browsing channels in a digital television device, according to an embodiment of the present invention.

Referring to FIG. 1, in step 102, blocks of moving window frames of a channel program are formed. A block is a set of moving window frames captured at a particular instance of time. The frames in the set of moving window frames differ by a duration ‘t’. Each block may have same or different number of captured moving window frames. If the moving window frames are encoded and transmitted, then a block is formed using decoded moving window frames. In such a case, the captured moving window frames are resized using an image processing library within the digital television device. Every block is associated with an adjacent block at a fixed interval.

The blocks are formed for each channel program watched by the user. For example, the blocks of moving window frames are formed while the user watches the channel program on a digital television device, until the user enters another channel or until the channel program ends. The blocks of moving window frames may include automatic block(s), associated block(s), dynamic block(s), a first fixed block, and a last fixed block.

In step 104, the blocks of moving window frames are stored in the memory of the digital television device. In step 106, a channel history list is generated based on the blocks of moving window frames. Additionally, information associated with the one or more channel programs is obtained using the associated one or more blocks stored in the memory. The channels browsed by the user during a period of time are identified based on the information. Further, a channel history list is formed based on the identified channels. Accordingly, when the number of blocks formed for a channel is less than a predetermined value, this implies that the channel was surfed at a rapid pace and therefore, not included in the channel history list.

In step 108, the channel history list is output on a display of the digital television device. For example, the channel history list is displayed when the viewer wishes to watch a channel program relayed on any of the channels previously browsed by the viewer.

In accordance with an embodiment of the present invention, the channel history list is output as an interactive graphical output that allows the viewer to select a channel program from the channel history list using an input device (e.g., a trackball, a remote control, a touch screen, or any other input device).

In accordance with an embodiment of the present invention, the output channel history list includes one or more channel programs watched by the viewer during a time period, information associated with each of the one or more channel programs, and a preview of the moving window frames in the blocks associated with each of the channel programs.

For example. the channel program information may include a channel program name, a channel program type, a channel program end time, duration for which the channel program is watched, associated channel name, and a channel number broadcasting the channel program. The channel program information may be used sort the channels in the channel history list. Also, the channels may be sorted based on a number of blocks formed per channel, program genre, program duration, channels in viewer's favorite list, etc.

For example, if a user frequent watches sports channels, more than news channels or regional channels, the channel history list may display sports channels at a top of the channel history list, followed by the news channels and the regional channels.

The preview of the moving window frames associated with each channel program is generated by selecting valid blocks in the blocks. Once the valid blocks are selected, the blocks are reordered based on the type of the blocks. For example, the preview of the moving window frames is displayed as an animation against each channel program associated with a channel in the channel history list. The preview of the moving window frames may be used by the viewer to quickly select a channel program from the channel history list, without memorizing the scene, channel program name. or channel program number. The channel history list may be displayed without interrupting the channel program currently running on the digital television device. For example, the channel history list may be displayed on a lower portion of the display in the digital television device, while the channel program currently running is displayed on an upper portion of the display.

In step 110, an input is received from the viewer for selecting a channel program from the one or more channel programs in the channel history list. As described above, the input may be received while the viewer watches a current channel program, i.e., the channel program currently running. In step 112, the current channel program is switched to the channel program selected by the viewer.

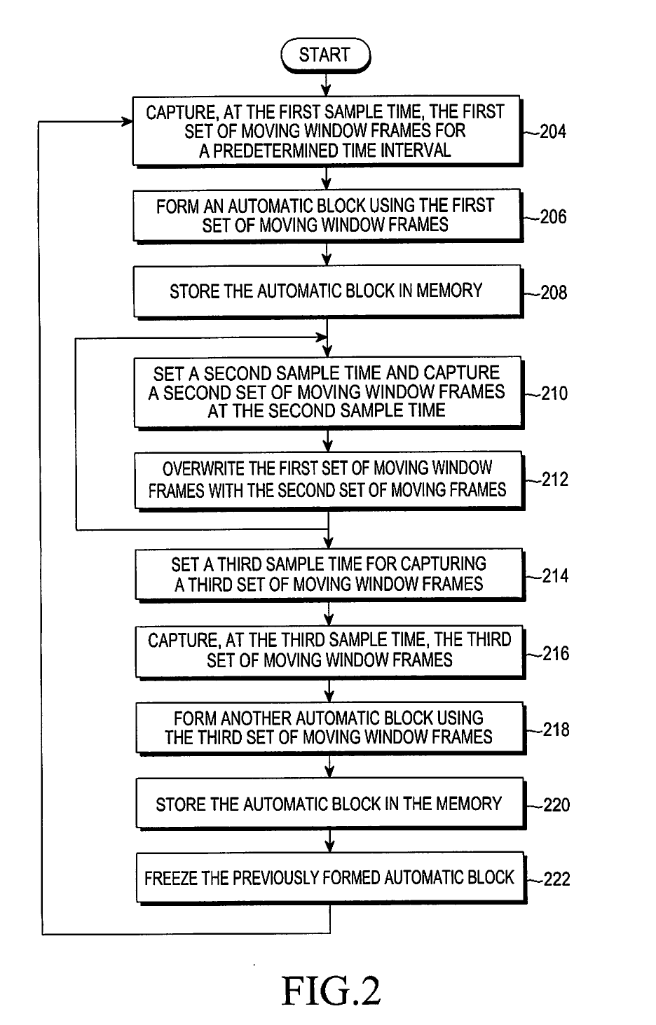

FIG. 2 is a flowchart illustrating a method of forming automatic blocks of moving window frames associated with each channel program being watched by a viewer, according to an embodiment of the present invention.

Referring to FIG. 2, after a first sample time for capturing a first set of moving window frames associated with a channel program being watched by the viewer is set, in step 204, the first set of moving window frames are captured at the first sample time for a predetermined time interval.

In step 206, an automatic block is formed using the first set of moving window frames. In step 208, the automatic block is stored in a memory of the digital television device. In step 210, a second sample time for capturing a second set of moving window frames associated with a channel program being watched by the user is set, and the second set of moving window frames are captured at the second sample time. In step 212, the digital television device overwrites the first set of moving window frames in the automatic block with the second set of moving window frames. The steps of 210 and 212 are repeated for a predefined time.

In step 214, a third sample time for capturing a third set of moving window frames associated with the channel program being watched by the user is set, and in step 216, the third set of moving window frames are captured at the third sample time for a predetermined time interval.

In step 218, another automatic block is formed using the third set of moving window frames. In step 220, the automatic block is stored in the memory of the digital television device. In step 222, the previously formed automatic block is frozen, i.e., will no longer be overwritten, after forming of another automatic block. Steps 204-222 are repeated until the end of the currently viewed program or until the user selects another channel.

Although FIG. 2 illustrates the previously formed automatic block being frozen after forming of another automatic block, in step 222, in accordance with another embodiment of the present invention, the previously formed automatic block is frozen at the same time as forming the another automatic block.

An example of forming one or more automatic blocks per channel is illustrated in Example A below.

### Example A

In this example, a current channel program duration being watched by the viewer is 45 minutes. Every 9 minutes a new block is introduced and the earliest block is simultaneously frozen. Initially, two blocks x[0], and x[1] are formed. Automatic blocks are continually formed until the viewer changes the channel, as given below:

Current Time is 0 mins 14 secs

Block x[0] will be formed at 30 secs

Block x[1] will be formed at 45 secs
Sampling interval from formation of the block x[1] (Inc) is 0 mins 22 secs
Sample time (n) is 1 mins 7 secs

### ********************

Current Time is 1 mins 6 secs

x[0] 1 mins 29 secs

x[1] 1 mins 51 secs
inc is 0 mins 55 secs
n is 2 mins 46 secs

### ********************

Current Time is 2 mins 45 secs

x[0] 3 mins 41 secs

x[1] 4 mins 36 secs
inc is 2 mins 18 secs
n is 6 mins 54 secs

### ********************

Current Time is 6 mins 53 secs

x[0] 9 mins 12 secs

x[1] 11 mins 30 secs
inc is 5 mins 45 secs
n is 17 mins 15 secs

### ********************

Current Time is 8 mins 59 secs

A new block x[2] is introduced at 9 mins 0 secs

x[0] is frozen at 3 mins 41 secs and not overwritten. x[1] and x[2] keeps overwriting.

x[1] 14 mins 45 secs

x[2] 20 mins 30 secs
inc is 6 mins 50 secs
n is 27 mins 20 secs

### ********************

Current Time is 17 mins 59 secs

A new block x[3] is introduced at 18 mins 0 secs

x[1] is frozen at 14 mins 45 secs and not overwritten. So, now x[0] and x[1] are frozen blocks and x[1] and x[2] keeps changing.

x[2] 24 mins 50 secs

x[3] 31 mins 40 secs
inc is 7 mins 55 secs
n is 39 mins 35 secs

### ********************

Current Time is 21 mins 57 secs and the viewer changes the channel at 21 minutes and 57 seconds. Thus, the final blocks obtained at 21 mins 57 secs are:

x[0] 3 mins 41 secs;

x[1] 14 mins 45 secs; and

x[2] 20 mins 30 secs.

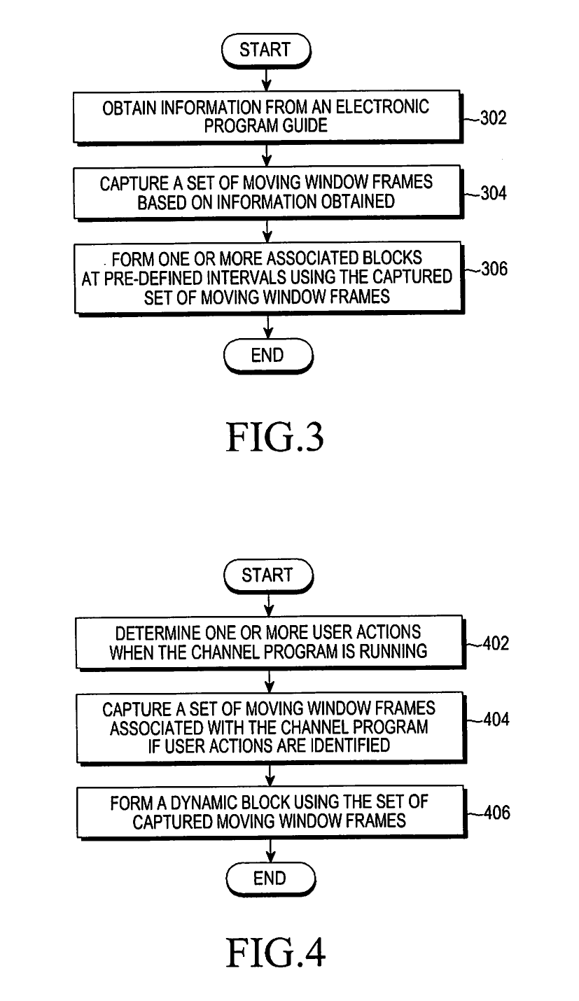

FIG. 3 is a flowchart illustrating a method of forming associated blocks of moving window frames associated with each channel program being watched by a viewer, according to an embodiment of the present invention.

Referring to FIG. 3, in step 302, information such as program type, program duration, etc., is obtained from an EPG. In step 304, a set of moving window frames is captured based on the obtained information. In step 306, one or more associated blocks are formed at predefined intervals using the captured set of moving window frames. For example, for a channel program of 30 minutes, wherein 12 minutes of the 30 minutes is dedicated to advertisements, which are shown 3-4 times for about 3-4 minutes each time, the associated blocks are formed at 3 minute intervals. The above-described time information associated with the channel program is obtained from the EPG.

FIG. 4 is a flowchart illustrating a method of forming dynamic blocks of moving window frames associated with each channel program being watched by a viewer, according to an embodiment of the present invention.

Referring to FIG. 4, in step 402, one or more user actions may be determined when a channel program is running on the digital television device. For example, the user actions may be adjusting the volume of the digital television device, adjusting brightness, sharpness, color, etc. In step 404, a set of moving window frames is captured, associated with the channel program when a user action is inputted. In step 406, a dynamic block is formed using the set of captured moving window frames.

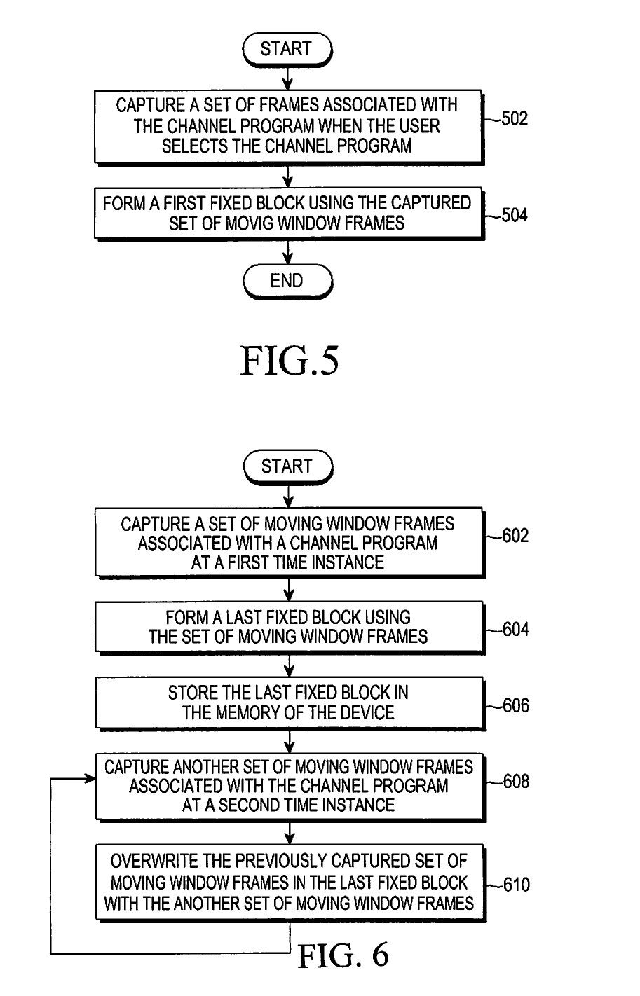

FIG. 5 is a flowchart illustrating a method of forming a first fixed block of moving window frames associated with each channel program being watched by a viewer, according to an embodiment of the present invention.

Referring to FIG. 5, in step 502, a set of moving window frames is captured when a viewer selects a channel for watching a channel program. In step 504, a first fixed block is formed using the captured set of moving window frames and stored in the memory of the digital television device.

FIG. 6 is a flowchart illustrating a method of forming a last fixed block of moving window frames associated with each channel program being watched by a viewer, according to an embodiment of the present invention.

Referring to FIG. 6, in step 602, a set of moving window frames associated with a channel program being watched by the viewer is captured at a first time. In step 604, a last fixed block is formed using the set of moving window frames. In step 606, the last fixed block is stored in the memory of the digital television device. In step 608, another set of moving window frames associated with the channel program is captured at a second time. In step 610, the previously captured set of moving window frames in the last fixed block is overwritten with the another set of moving window frames. The process is repeated until the user switches to another channel program or the current channel program ends.

In accordance with an embodiment of the present invention, a non transitory computer-readable storage medium may be provided for storing channel browsing instructions, which when executed by a computing platform (e.g., mobile phone, personal computer, laptop, etc.), cause the computing platform to perform any of the methods illustrated in FIGS. 1-6.

After the first fixed block, the automatic blocks, the associated blocks, the dynamic blocks, and the last fixed blocks are formed, as described above, a channel program and associated information are added to the channel history list. For example, after surfing through the channels, when the viewer wishes to watch one of the previously surfed channels, then a channel history list is presented to the viewer as an interactive graphical output as will be described below.

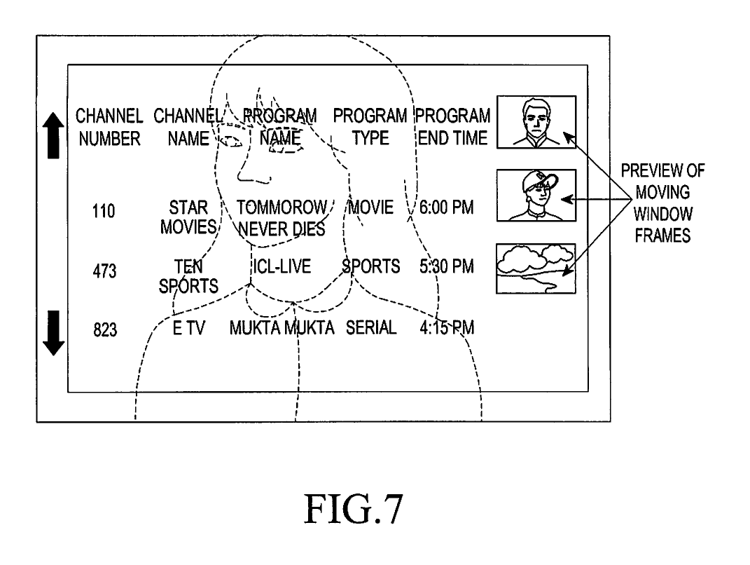

FIG. 7 illustrates a screenshot of an interactive graphical output displayed on a display of a digital television device, according to an embodiment of the present invention.

Referring to FIG. 7, the interactive graphical output displays channel programs watched by the viewer during a time period, associated channel numbers, channel names, channel program types, channel program names, channel program end times, and previews of the moving window frames captured in the blocks for the particular channels.

Accordingly, using the interactive graphical output, the viewer can selects a desired channel program from the channel history list using an input device (e.g., based on the preview of moving window frames and other information). The preview of the moving window frames associated with the channel program helps the user to easily identify a desired channel program from the channel history list. Upon receiving an input, the digital television device relays the channel program selected from the channel history list.

For example, a user is watching a movie ‘Tomorrow Never Dies’ aired on Star Movies. The user watches the movie for 7 minutes and starts browsing other channels at a rapid pace. The user then tunes to a TEN SPORTS channel and watches for about 6 minutes. The channel browsing method discards all the browsed channels at a rapid pace; however, the TEN SPORTS channel is added to the channel history list. The user then selects an ETV channel, where a serial is being aired and watches for 12 minutes. This channel is also added to the channel history list.

Additionally, when an advertisement is aired on the ETV channel, the user skips many channels and halts at a BBC news channel and watches for about 4 minutes.

After the 4 minutes, the user changes the BBC news channel and selects a U2 channel where a song is being played and watches for about 10 seconds. Now, the user feels that the advertisement break on the ETV channel is over and wishes to go back and finish watching the serial.

Accordingly, the user enters an input to show the channel history list. The channel history list is displayed along with the preview of respective channel programs aired on the digital television device. This helps the user to select the ETV channel by viewing the preview of the serial and other information, without having to remember the channel number.

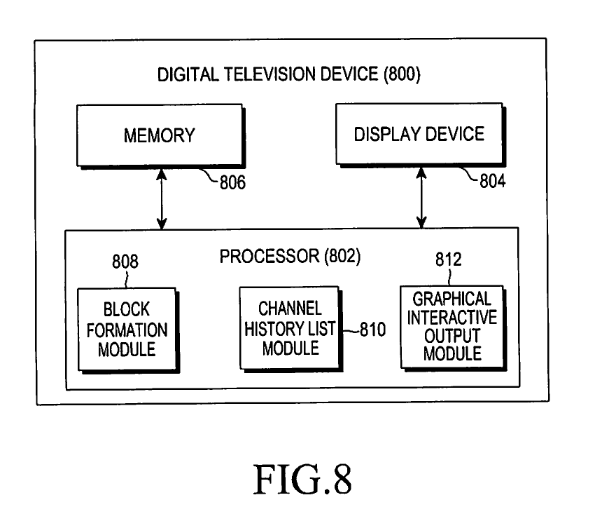

FIG. 8 is a block diagram illustrating a digital television device implementing channel browsing methods, according to an embodiment of the present invention.

Referring to FIG. 8, the digital television device 800 includes a processor 802, a display device 804 coupled to the processor 802, and a memory 806 coupled to the processor 802. The processor 802 includes a block formation module 808, a channel history list module 810, and a graphical interactive output module 812.

In operation, the block formation module 808 forms one or more blocks of moving window frames associated with each channel program that is being watched by a viewer of the digital television device 800, and then stores the one or more blocks in the memory 806. The channel history list module 810 generates a channel history list based on the one or more blocks of moving window frames. The channel history list module 810 then sorts the channel programs based on predetermined criteria. The predetermined criteria may include a number of blocks formed per channel program, a random manner, a channel program end time, a channel program type, a channel program genre, a channel classification, a channel program language, and an order in which channels were browsed.

The graphical interactive output module 812 outputs the channel history list on the display device 804. Specifically, the graphical interactive output module 812 outputs the channel history list as a graphical interactive output such that the viewer can select a channel program from the channel history list using an input device (not shown) of the digital television device 800.

The output channel history list includes one or more channel programs browsed by the viewer over a period of time, information associated with each of the one or more channel programs, and a preview of the moving window frames in the blocks associated with each of the one or more channel programs.

In accordance with an embodiment of the present invention, the graphical interactive output module 812 selects valid blocks in the one or more blocks associated with each channel program.

In accordance with an embodiment of the present invention, the graphical interactive output module 812 reorders the selected blocks based on a type of the blocks and outputs a preview of the moving window frames in the reordered blocks associated with the channel program watched by the user against each associated channel in the channel history list.

Moreover, the graphical interactive output module 812 receives an input from the viewer for selection of a channel program from the one or more channel programs in the output channel history list. Further, the graphical interactive output module 812 switches from a current channel program to the channel program selected by the viewer. The block formation module 808 forms the one or more blocks according to the methods described in FIGS. 2-6.

Although, implementation of the channel browsing methods described above are given with respect to a digital television device, the methods of FIGS. 1-6 may also be implemented in other similar devices such as a set-top box or a digital television receiver.

While the present invention has been shown and described with reference to certain embodiments thereof, it will be understood by those skilled in the art that various changes in form and details may be made therein without departing from the spirit and scope of the present invention as defined by the appended claims.

What is claimed is:

1. A method of browsing channels in a digital television device, the method comprising the steps of:
forming one or more blocks of moving window frames associated with each channel program being watched by a viewer of the digital television device;
generating a channel history list based on the one or more blocks of the moving window frames; and
displaying the channel history list on a display of the digital television device,
wherein the channel history list includes at least one of the channel programs watched by the viewer, information associated with each of the at least one of the channel programs, and a preview of the moving window frames in the one or more blocks associated with each of the at least one of the channel programs.

2. The method of claim 1, further comprising:
receiving an input from the viewer for selecting of a channel program from the at least one of the channel programs in the channel history list; and
switching from a current channel program to the channel program selected by the viewer.

3. The method of claim 1, further comprising:
storing the one or more blocks of the moving window frames in a memory of the digital television device.

4. The method of claim 1, wherein forming the one or more blocks of the moving window frames associated with each channel program being watched by the viewer of the digital television device comprises:
setting a first sample time for capturing a first set of moving window frames associated with a channel program being watched by the viewer;
capturing, at the first sample time, the first set of moving window frames;
forming a first automatic block using the first set of moving window frames;
storing the first automatic block in a memory of the digital television device;
setting a second sample time for capturing a second set of moving window frames associated with the channel program being watched by the viewer;
overwriting the first set of moving window frames in the first automatic block with the second set of moving window frames;
setting a third sample time for capturing a third set of moving window frames associated with the channel program being watched by the viewer;
capturing, at the third sample time, the third set of moving window frames;
forming a second automatic block using the third set of moving window frames;
storing the second automatic block in the memory of the digital television device; and
freezing the first automatic block.

5. The method of claim 4, wherein the second automatic block is formed based on a duration of the channel program being watched by the viewer.

6. The method of claim 1, wherein forming the one or more blocks of the moving window frames associated with each channel program being watched by the viewer of the digital television device comprises:
capturing a set of moving window frames based on information obtained from an electronic program guide; and
forming one or more associated blocks using the captured set of moving window frames.

7. The method of claim 1, wherein forming the one or more blocks of the moving window frames associated with each channel program being watched by the viewer of the digital television device comprises:
identifying one or more user inputs when a channel program is running;
capturing a set of moving window frames associated with the channel program based on the identified one or more user actions; and
forming a dynamic block using the captured set of the moving window frames.

8. The method of claim 1, wherein forming the one or more blocks of the moving window frames associated with each channel program being watched by the viewer of the digital television device comprises:
capturing a set of moving window frames associated with a channel program, when the viewer selects the channel program; and
forming a first fixed block using the captured set of the moving window frames.

9. The method of claim 1, wherein forming the one or more blocks of the moving window frames associated with each channel program being watched by the viewer of the digital television device comprises:
capturing a first set of moving window frames associated with a channel program at a first time;
forming a last fixed block using the set of moving window frames;
storing the last fixed block in a memory of the digital television device;
capturing another second set of moving window frames associated with the channel program at a second time; and
overwriting the first set of the moving window frames in the last fixed block with the second set of the moving window frames.

10. The method of claim 1, wherein generating the channel history list based on the one or more blocks comprises:
obtaining information associated with each channel program using the associated one or more blocks stored in the memory;
identifying channels browsed by the viewer during a period of time;
forming the channel history list based on the identified channels.

11. The method of claim 1, wherein the at least one of the channel programs in the channel history list are displayed in ascending, descending, or random order based on a number of blocks formed for each of the at least one of the channel programs.

12. The method of claim 1, wherein, in generating the channel history list, a channel is added to the channel history list if a total number of blocks formed for the channel is greater than or equal to a predetermined value.

13. The method of claim 1, wherein displaying the channel history list comprises:
selecting blocks in the one or more blocks associated with each channel program;
reordering the selected blocks based on a type of the blocks;
outputting a preview of the moving window frames in the reordered blocks associated with the channel program watched by the viewer for each associated channel in the channel history list.

14. The method of claim 1, wherein the information associated with each of the one or more channel programs includes at least one of a channel program name, a channel program type, a channel program end time, a channel program type, a duration for which a channel program is watched, an associated channel name, and a channel number broadcasting a channel program.

15. An apparatus for browsing channels in a digital television device, the apparatus comprising:
a display device;
a processor that forms one or more blocks of moving window frames associated with each channel program being watched by a viewer of the digital television device, generates a channel history list based on the one or more blocks of the moving window frames, and displays the channel history list on the display of the digital television device; and
a memory for storing the one or more blocks and the channel history list,
wherein the channel history list includes at least one of the channel programs browsed by the viewer, information associated with each of the at least one of the channel programs, and a preview of the moving window frames in the one or more blocks associated with each of the at least one of the channel programs.

16. The apparatus of claim 15, further comprising an input device though which the viewer inputs a selection of a channel program from the at least one of the channel programs in the channel history list,
wherein the processor switches from a current channel program to the channel program selected by the viewer.

17. The apparatus of claim 15, wherein the processor sets a first sample time for capturing a first set of moving window frames associated with a channel program being watched by the viewer, captures, at the first sample time, the first set of the moving window frames, forms a first automatic block using the first set of moving window frames, and stores the first automatic block in the memory, and
wherein the processor sets a second sample time for capturing a second set of moving window frames associated with the channel program being watched by the viewer, overwrites the first set of moving window frames in the first automatic block with the second set of the moving window frames, sets a third sample time for capturing a third set of moving window frames associated with the channel program being watched by the viewer, captures, at the third sample time, the third set of the moving window frames, forms a second automatic block using the third set of moving window frames, stores the second automatic block in the memory, and freezes the first automatic block.

18. The apparatus of claim 15, wherein the processor captures a set of moving window frames based on information in an electronic program guide, and forms one or more associated blocks using the captured set of the moving window frames.

19. The apparatus of claim 15, wherein the processor monitors one or more user actions when a channel program is running, captures a set of moving window frames associated with the channel program, when the one or more user actions are identified, and forms a dynamic block using the captured set of the moving window frames.

20. A non-transitory computer-readable storage medium for storing executable instructions, that when executed by a computing platform of a digital television device, result in performing a method of:
forming one or more blocks of moving window frames associated with each channel program being watched by a viewer of the digital television device;
generating a channel history list based on the one or more blocks of the moving window frames; and
displaying the channel history list on a display of the digital television device,
wherein the channel history list includes at least one of the channel programs watched by the viewer, information associated with each of the at least one of the channel programs, and a preview of the moving window frames in the one or more blocks associated with each of the at least one of the channel programs.
